(19) United States
(12) Patent Application Publication
(10) Pub. No.: US 2021/0150554 A1
(43) Pub. Date: May 20, 2021

(54) SYSTEMS AND METHODS FOR ELECTRONICALLY FORMING, CLUSTERING AND MANAGING A PLURALITY OF STRATEGICALLY PLOTTED LOCATIONS

(71) Applicant: United States Postal Service, Washington, DC (US)

(72) Inventors: Dan Patrick Houston, JR., Wake Forest, NC (US); Brad Kristin Verburgt, Cary, NC (US); Justin Riggins, Washington, DC (US); John Greaves, Washington, DC (US); Elizabeth Ann Potter Copello, Raleigh, NC (US)

(21) Appl. No.: 16/951,867

(22) Filed: Nov. 18, 2020

Related U.S. Application Data
(60) Provisional application No. 62/937,918, filed on Nov. 20, 2019.

(51) Int. Cl. G06Q 30/02; G06Q 50/32; G06Q 10/08

(52) U.S. Cl. CPC G06Q 30/0205; G06Q 10/0838; G06Q 50/32; G06Q 30/0201

(57) ABSTRACT

The present disclosure relates to a method and system for electronically forming a plurality of local areas of commerce on a computerized map. In one aspect, the method includes obtaining, by a processor, mail volume data, census data and vacancy data for the geographical area. The method also includes computing, by the processor, data relationships among the mail volume data, the census data and the vacancy data, identifying, by the processor, longitude and latitude values of the geographical area, and creating, by the processor, an appropriate grid of the geographical area using decimal precision. The method further includes combining, by the processor, the computed data relationships and the created appropriated grid to produce a combined data set and dividing, by the processor, the geographical area into a plurality of strategically plotted locations over time (SPLOTs) based on the combined data set.

### RELATED APPLICATIONS

This application claims priority to and the benefit of Provisional Application No. 62/937,918 filed on Nov. 20, 2019 in the U.S. Patent and Trademark Office, the entire content of which is incorporated herein by reference.

### BACKGROUND

The described technology generally relates to systems and methods for electronically forming, clustering and managing a plurality of strategically plotted locations over time (SPLOTs).

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems, devices, and methods for electronically forming, clustering and managing a plurality of SPLOTs.

One aspect is a method of electronically forming a plurality of local areas of commerce, the method comprising: obtaining, by a processor, characteristic data for a geographical area; creating, by the processor, a grid of the geographical area; combining, by the processor, the characteristic data and the grid to produce a combined data set; and dividing, by the processor, the geographical area into a plurality of geographic units based on the combined data set.

In the above method, the characteristic data comprises item volume data or a number of delivery points for the geographical area. In the above method, the characteristic data further comprises population data. In the above method, the characteristic data comprises vacancy data for the geographical area. The above method further comprises: clustering, by the processor, geographic units having similar characteristics based on the combined data set to generate a plurality of clusters; and generating, by the processor, the clustered geographic units on a digital map, wherein the plurality of clusters are visually distinguishable. In the above method, the combining is performed for a plurality of regions of the geographical area respectively having a plurality of distances from a geographical point, and wherein the plurality of distances comprise a smallest distance, at least one intermediate distance and a largest distance.

In the above method, the combining is performed sequentially for the plurality of regions from the smallest distance to the largest distance. In the above method, the smallest distance is in the range of 0.1 to 10 miles, and wherein the largest distance is in the range of 2.5 miles to 3,000 miles. In the above method, the combining is sequentially performed by 1 mile increment for 10 regions of the geographical area respectively having distances of 1-10 miles from the geographical point.

Another aspect is a method of electronically forming a plurality of local areas of commerce, the method comprising: selecting, by a processor, a geographical area to be divided; dividing, by the processor, the selected geographical area into a plurality of strategically plotted locations over time (SPLOTs), wherein each of the SPLOTs has at least one characteristic; selecting, by the processor, at least one SPLOT, from the plurality of SPLOTs, having a first characteristic as a main SPLOT; determining, by the processor, characteristics of SPLOTs surrounding the main SPLOT; and grouping together, by the processor, SPLOTs having characteristics the same as or similar to the first characteristic.

The above method further comprises indicating, by the processor, the grouped SPLOTs on a computerized map to be visually distinguishable from different groups of SPLOTs. In the above method, the characteristic comprises one or more of the following: the number of population density, the number of retail stores, schools and/or government offices, the number of priority mail 1 day services and volumes, a mail volume per population, a mail volume per land area, the number of businesses, the number of residential buildings, the number of vacant buildings, customer behavior, business partner behavior patterns, the number of addresses, the number of primary business partners per population, and the number of primary business partners per land area, for the selected geographical area. In the above method, each of the SPLOTs comprises at least one item delivery point.

In the above method, the grouping comprises: defining, by the processor, at least one characteristic each having a weight to classify the SPLOTs; ranking, by the processor, the SPLOTs based on the defined characteristic; classifying, by the processor, SPLOTs having the same or similar ranks into the same group; and creating, by the processor, a cluster including all SPLOTs in the same group.

Another aspect is a method of electronically managing a plurality of strategically plotted locations over time (SPLOTs), the method comprising: defining, by a processor, one or more characteristics each having a weight to classify SPLOTs; classifying, by the processor, the plurality of SPLOTs into clusters; selecting, by the processor, at least one SPLOT from the SPLOTs to evaluate, wherein the selected SPLOT belongs to a first cluster; calculating, by the processor, a weighted score for the selected SPLOT at a first point of time to obtain first ranking; calculating, by the processor, a weighted score for the selected SPLOT at a second point of time different from the first point of time to obtain second ranking; comparing, by the processor, the first and second rankings; and managing, by the processor, the selected SPLOT based on the comparing.

In the above method, the managing comprises maintaining, by the processor, the selected SPLOT in the first cluster when the second ranking is the same as the first ranking. In the above method, the managing comprises re-clustering, at the processor, the selected SPLOT to another different cluster when the second ranking is different from the first ranking. In the above method, the one or more characteristics comprise a plurality of characteristics, and wherein the weighted score comprises a sum of the weights or an average of the sum of the weights.

Another aspect is a system for electronically forming a plurality of local areas of commerce, the system comprising: a database configured to store mail volume data, census data and vacancy data, for a geographical area; and a processor in data communication with the database and configured to: retrieve the mail volume data, the census data and the vacancy data, for the geographical area; compute data relationships among the mail volume data, the census data and the vacancy data; identify longitude and latitude coordinate values of the geographical area; create an appropriate grid of the geographical area using decimal precision; combine the computed data relationships and the created appropriated grid to produce a combined data set, and divide the geographical area into a plurality of strategically plotted locations over time (SPLOTs) based on the combined data set.

In the above system, the mail volume data comprises data processed by mailer, mail class or delivery type. In the above system, the census data comprises one or more of a population density, the number of businesses, the number of residential buildings, the number of addresses, the number of primary business partners per population, the number of primary business partners per land area, P.O. Box count, mortgage, delivery point location, property land value, delivery point type, home value, or household income. In the above system, the vacancy data comprises one or more of residential vacancy data, commercial vacancy data or P.O. Box vacancy data. In the above system, the processor is further configured to: group SPLOTs having similar characteristics; and indicate the grouped SPLOTs on a computerized map to be visually distinguishable from different groups of SPLOTs.

Another aspect is a system for electronically forming a plurality of local areas of commerce, the system comprising: a processor; and a memory configured to store instructions, when executed, configured to cause the processor to: select a geographical area to be divided; divide the selected geographical area into a plurality of strategically plotted locations over time (SPLOTs), wherein each of the SPLOTs has at least one characteristic; select at least one SPLOT, from the plurality of SPLOTs, having a first characteristic as a main SPLOT; determine characteristics of SPLOTs surrounding the main SPLOT; determine, by the processor, SPLOTs having characteristics the same as or similar to the first characteristic; group, by the processor, the determined SPLOTs together; and indicate, by the processor, the grouped SPLOTs on a computerized map to be visually distinguishable from different groups of SPLOTs.

In the above system, the characteristic comprises one or more of the following: the number of population density, the number of retail stores, schools and/or government offices, the number of priority mail 1 day services and volumes, a mail volume per population, a mail volume per land area, the number of businesses, the number of residential buildings, the number of vacant buildings, customer behavior, business partner behavior patterns, the number of addresses, the number of primary business partners per population, and the number of primary business partners per land area, for the selected geographical area.

In the above system, the memory is further configured to cause the processor to perform: define at least one characteristic each having a weight to classify the SPLOTs; rank the SPLOTs based on the defined characteristic; classify SPLOTs having the same or similar ranks into the same group; and create a cluster including all SPLOTs in the same group. In the above system, each of the SPLOTs comprises at least one item delivery point.

Another aspect is a system for electronically managing a plurality of strategically plotted locations over time (SPLOTs), the system comprising: a processor; and a memory configured to store instructions, when executed, configured to cause the processor to perform: define one or more characteristics each having a weight to classify the plurality of SPLOTs; classify the plurality of SPLOTS into clusters; select at least one SPLOT from the plurality of SPLOTs to evaluate, wherein the selected SPLOT belongs to a first cluster; calculate a weighted score for the selected SPLOT at a first point of time to obtain first ranking; calculate a weighted score for the selected SPLOT at a second point of time different from the first point of time to obtain second ranking; compare the first and second rankings; and manage the selected SPLOT based on the comparing.

In the above system, the memory is further configured, in managing the selected SPLOT, to cause the processor to maintain the selected SPLOT in the first cluster when the second ranking is the same as the first ranking. In the above system, the memory is further configured, in managing the selected SPLOT, to cause the processor to re-cluster the selected SPLOT to another different cluster when the second ranking is different from the first ranking.

Another aspect is a method of electronically forming a plurality of local areas of commerce, the method comprising: obtaining, by a processor, mail volume data for a geographical area; obtaining, by the processor, census data for the geographical area; obtaining, by the processor, vacancy data for the geographical area; computing, by the processor, data relationships among the mail volume data, the census data and the vacancy data; identifying, by the processor, longitude and latitude coordinate values of the geographical area; creating, by the processor, an appropriate grid of the geographical area using decimal precision; combining, by the processor, the computed data relationships and the created appropriated grid to produce a combined data set; and dividing, by the processor, the geographical area into a plurality of strategically plotted locations over time (SPLOTs) based on the combined data set.

In the above method, the mail volume data comprises data processed by mailers, mail class or delivery type, for the geographical area. In the above method, the census data comprises one or more of a population density, the number of businesses, the number of residential buildings, the number of addresses, the number of primary business partners per population, the number of primary business partners per land area, P.O. Box count, mortgage, delivery point location, property land value, delivery point type, home value, or household income, for the geographical area.

In the above method, the vacancy data comprises one or more of residential vacancy data, commercial vacancy data or P.O. Box vacancy data, for the geographical area. The above method further comprises: grouping together, by the processor, SPLOTs having similar characteristics; and indicating, by the processor, the grouped SPLOTs on a computerized map to be visually distinguishable from different groups of SPLOTs.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1A illustrates a Zip Code map of the United States.

FIG. 1B illustrates a Zip Code map of several counties of the state of California.

FIG. 2 illustrates a conceptual diagram showing an embodiment of how SPLOTs are formed, clustered and managed according to some embodiments.

FIG. 3 illustrates an exemplary block diagram of a system for electronically forming, clustering and managing a plurality of SPLOTs according to some embodiments.

FIG. 4 illustrates an exemplary process flow diagram of a method for electronically forming SPLOTs according to some embodiments.

FIG. 5 illustrates an exemplary process flow diagram of a method for electronically clustering SPLOTs that have been formed according to some embodiments.

FIG. 6 illustrates an exemplary process flow diagram of a method for electronically managing generated SPLOTs according to some embodiments.

FIG. 7 illustrates an exemplary process flow diagram of a method for electronically forming SPLOTs according to some embodiments.

FIG. 8A illustrates an exemplary SPLOT map showing different groups of SPLOTs in different colors or shadings when one characteristic is used to identify each SPLOT according to some embodiments.

FIG. 8B illustrates an exemplary SPLOT map showing different groups of SPLOTs in different colors or shadings when multiple characteristics are used identify each SPLOT according to some embodiments.

FIG. 9 is a block diagram of an exemplary computing device illustrated in FIG. 3 according to some embodiments.

### DETAILED DESCRIPTION

Provided herein are various embodiments of systems and methods for electronically forming a plurality of strategically plotted locations over time (SPLOTs). Some embodiments provide systems and methods for electronically clustering SPLOTs that have been formed. Some embodiments provide systems and methods for electronically managing the SPLOTs and clusters. Some embodiments provide systems and methods for using clustered SPLOTs in commerce. Some embodiments keep track of changes in SPLOTs over time to determine potential use cases. Various embodiments can provide many benefits including (but not limited to) forecasting package volumes at SPLOT levels, predicting changes in number of delivery points and types, determining patterns at a lower or higher level, or an alternate level or granularlity, than a Zip Code, determining competitors' behaviors, developing new delivery pricing agreement, improving scheduling and service class performance, dividing or allocating a geographic area in an optimal or efficient way, estimating competitors' delivery costs, etc.

In the following detailed description, reference is made to the accompanying drawings, which form a part hereof. In the drawings, similar symbols typically identify similar components, unless context dictates otherwise. Thus, in some embodiments, part numbers may be used for similar components in multiple figures, or part numbers may vary from figure to figure. The illustrative embodiments described in the detailed description, drawings, and claims are not meant to be limiting. Some embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Reference in the specification to “one embodiment,” “an embodiment,” or “in some embodiments” means that a particular feature, structure, or characteristic described in connection with the embodiment is included in at least one embodiment of the present disclosure. Moreover, the appearance of these or similar phrases throughout the specification do not necessarily all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for some embodiments.

As used here, the term “item” or “items” may refer to flats, letters, parcels, residual mail, and the like. Although the present disclosure describes systems and devices for image processing related to articles of mail, such as letters and flats, it will be apparent to one of skill in the art that the disclosure presented herein is not limited thereto. For example, the described technology may have application in a variety of manufacturing, assembly, distribution, or sorting applications that include processing images including personal or sensitive information at high rates of speed and volume.

Reference will now be made in detail to the present embodiments, examples of which are illustrated in the accompanying drawings. Wherever possible, the same reference numbers will be used throughout the drawings to refer to the same or like parts.

A distribution network can distribute and/or deliver items to a plurality of geographic areas, which can be local or can be nationwide. The distribution network can use its delivery resources, such as vehicles, carriers, employees, and rolling stock can be identified within geographic areas, and this information can be provided to shippers, distributors, merchants, retailers, or any other group that may wish to deliver one item or bulk items to a geographic area. The distribution network can divide an area, such as a country, state, city, etc., into a plurality of geographic areas. Boundaries can be set according to relative population of the area. The number of postal facilities, postal vehicles, rolling stock, carriers, processing facilities, postal employees, etc., are determined for the geographic area. Typical mail volumes, including historical volumes for times of the year such as holiday surges are assigned to the geographic area. For each geographic area, the distribution network assets will be identified. In the example of the United States Postal Service (USPS), each processing center, post office, vehicle, carrier, employee, and the capacity for each, will be identified.

A distribution network may comprise multiple levels. For example, a distribution network may comprise regional distribution facilities, hubs, and unit delivery facilities, or any other desired level. For example, a nationwide distribution network may comprise one or more regional distribution facilities having a defined coverage area (such as a geographic area), designated to receive items from intake facilities within the defined coverage area, or from other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or many unit delivery facilities, and can sort and deliver items to the unit delivery facilities with which it is associated. In the case of the USPS, the unit delivery facility may be associated with a ZIP Code. The unit delivery facility receives items from local senders, and from hub level facilities or regional distribution facilities. The unit delivery facility also sorts and stages the items intended for delivery to destinations within the unit delivery facility's coverage area.

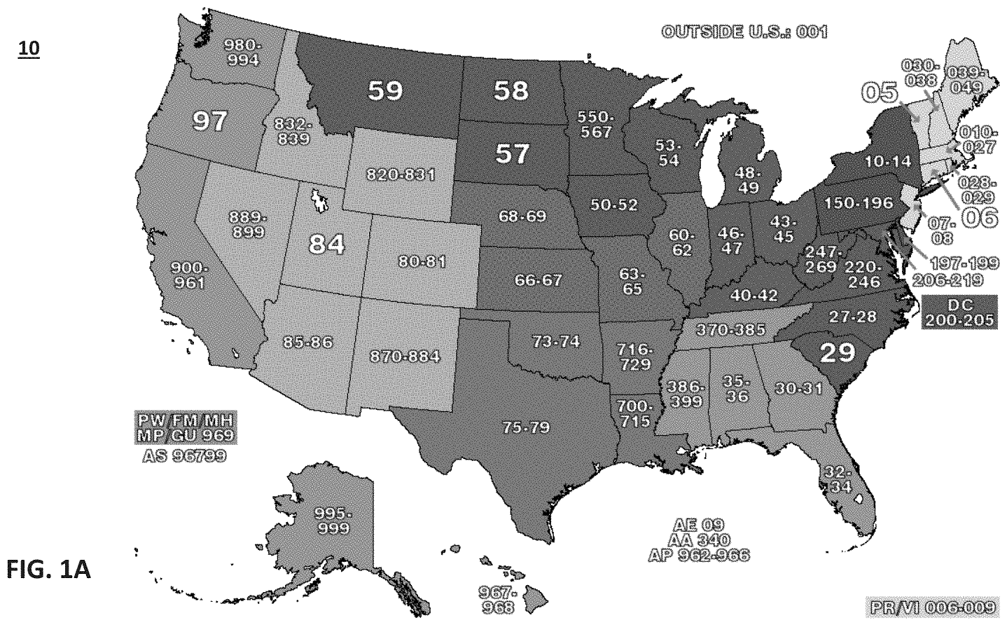

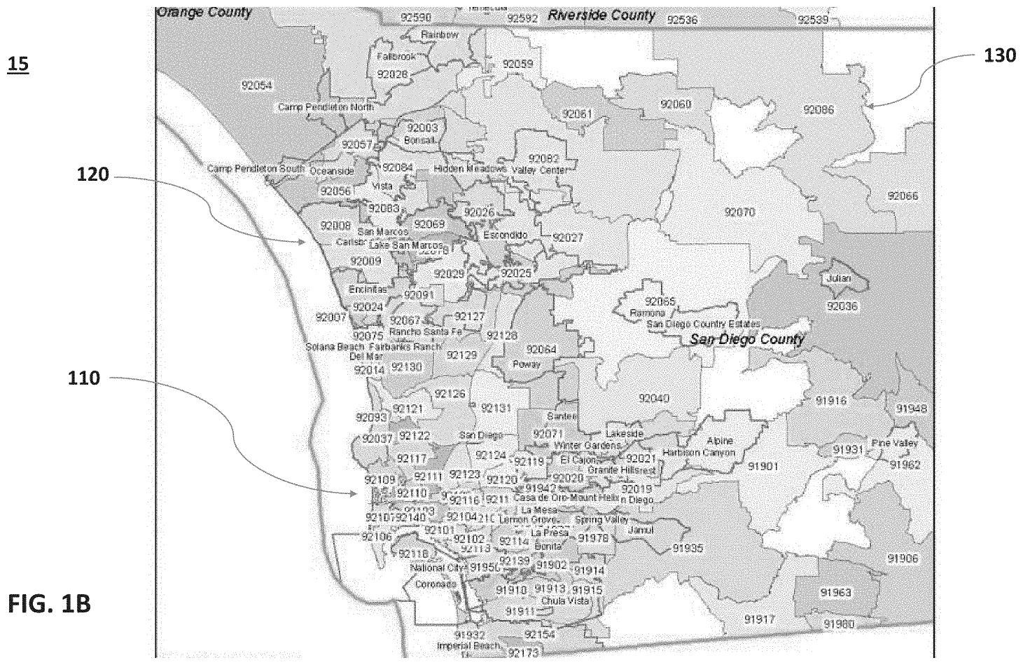

FIG. 1A shows a Zip Code map 10 of the United States. A ZIP Code indicates a geographic area, which can include a destination post office or delivery area to which a mail will be sent for final sorting for delivery. There are three main parts of the 5-digit ZIP Code—the national area, the region or city, and the delivery area. As shown in FIG. 1A, the USPS currently segments the country into 10 ZIP Code areas. Starting in the northeast, they are numbered 0-9. After the first number in a ZIP Code is assigned, the USPS assigns the next two numbers according to city. The first three digits of a ZIP Code together usually indicate the sectional center facility to which the ZIP Code belongs. This facility is a mail sorting and distribution center for a zone or area. Some sectional center facilities have multiple three-digit codes assigned to them. As of 2015, there were over 42,000 ZIP Codes in the United States. ZIP Codes can be used not only for tracking mail but also in gathering other information such as geographical statistics in the United States.

FIG. 1B shows another Zip Code map 15 of several counties of the California state of the United States. The Zip Code map 15 includes a denser area 110, a less dense area 130 and an intermediate area 120. The denser area 110 may be more populated than surrounding or neighboring areas and can include, for example, downtowns. The denser area 110 may include the most dense area in the counties. The less dense area 130 may be less populated than surrounding areas and can include, for example, rural areas. The less dense area 130 may include the least dense area in the counties. The intermediate area 120 may have a density or population between the denser area 110 and the less dense area 130, and can include, for example, suburban areas.

Referring to FIG. 1B, generally, the denser area 110 may include relatively more ZIP Codes each ZIP code area typically smaller than those of the intermediate area 120 and the less dense area 130. In contrast, the less dense area 130 may include relatively less ZIP Codes each ZIP Code area generally larger than those of the intermediate area 120 and the denser area 110. This means that mail delivery time may be different from one ZIP Code area to another adjacent ZIP Code area in each of the areas 110-130 depending on whether the destination point is in the denser area 110, the less dense area 130 or the intermediate area 120.

Currently, the USPS has the most comprehensive delivery network, as they generally deliver items to all of the ZIP Code areas in the U.S. Since, other shipping companies do not deliver items to certain ZIP Code areas or to some geographic areas, they are generally partnered with the USPS to deliver items to the ZIP Code regions in which they do not deliver themselves. In working with these business partners, the USPS is generally paid by based on ZIP Codes. For example, the business partners pay the USPS at the same rate for any delivery points within the same ZIP Code area regardless of the size of the ZIP Code area. Since the rural areas are generally significantly larger in size than the denser areas, the USPS may use different resources in those areas and the cost for delivering items within different ZIP codes can vary widely. Thus, there is a need to introduce a new area system that can cover areas smaller than ZIP Code areas for mail delivery purpose and other non-mail related activities or events. ZIP Codes are used here as an example. Other mechanisms for identifying geographic boundaries, political divisions, etc., can be utilized without departing from the scope of this disclosure.

Some aspects described herein include systems and methods for electronically forming a plurality of strategically plotted locations over time (SPLOTs). As one example, each of the SPLOTs can be smaller than a ZIP Code area. Zip Codes are used as an example herein, but a person of skill in the art, guided by this disclosure will understand that the dimensions of a SPLOT can be of any desirable size. Some aspects also include systems and methods for electronically clustering the created SPLOTs. The SPLOTs can be clustered based on many different factors such as similarity in regions, populations, etc. Some aspects include systems and methods for electronically managing the created SPLOTs and the clusters of SPLOTs. SPLOTs can have many different use cases such as pricing negotiation among mail delivery business partners. For example, even in the same ZIP Code area, mail delivery costs can be differently determined based on different SPLOTs. For example, when 20 SPLOTs can replace a particular single ZIP Code area, different mail delivery fees can be applied to some or all of the 20 SPLOTs.

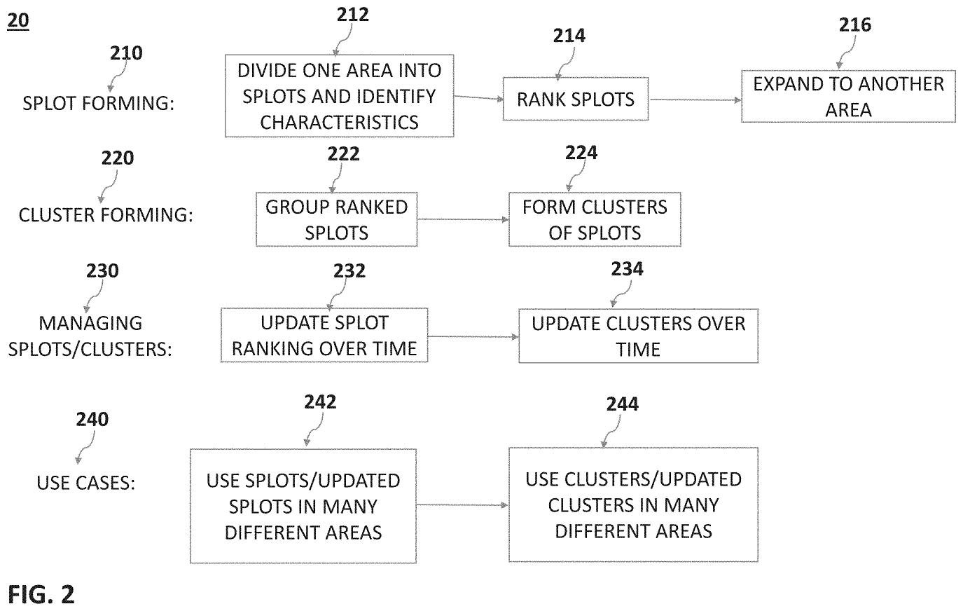

FIG. 2 illustrates a conceptual diagram 20 showing how SPLOTs are formed, clustered and managed according to some embodiments. Although the conceptual diagram 20 is described herein with reference to a particular order, in various embodiments, states herein may be performed in a different order, or omitted, and additional states may be added.

The diagram 20 includes procedures for SPLOT forming 210, cluster forming 220, managing SPLOTs/clusters 230 and use cases 240. The SPLOT forming procedure 210 may include states 212-216 for dividing (212), ranking (214) and expanding (216) SPLOTs. In state 212, one geographical area (e.g., town, city, county, state, whole country, etc.) may be divided into a plurality of SPLOTs, and characteristics for each SPLOT can be determined. Each SPLOT may be smaller in size than the city, county, state, ZIP Code area, etc. Depending on the embodiments or use cases, SPLOTs can be sized differently. SPLOTs can have different shapes, for example, square, rectangle, circle or polygonal or random shapes. SPLOTs can be formed in many different ways.

In some embodiments, each SPLOT can be formed and/or sized to include at least one delivery point. In some embodiments, SPLOTs can be formed and/or sized based on population (e.g., population density). For example, a certain number of population (e.g., up to 1,000, up to 5,000 or up to 10,000) can form one SPLOT. In still some embodiments, SPLOTs can be formed and/or sized based on the number of particular buildings, for example, retail stores, schools and/or government offices, etc. For example, each SPLOT can be formed and/or sized to include at least one school, at least one retail store and/or at least one government office. SPLOTs can also be formed based on one or more factors or characteristics including, but not limited to, an item volume, an item volume per type, for example, the number of priority mail 1 day services and volumes, an item volume per population, an item volume per land area, the number of businesses, the number of residential buildings, the number of vacant buildings, customer behavior, business partner behavior patterns, the number of addresses, the number of primary business partners per population, and the number of primary business partners per land area. In some embodiments, a SPLOTs can be formed based on land area. Again, these characteristics are merely examples, and SPLOTs can be formed, identified and/or classified based on other characteristics.

The quantity or weight of the selected or chosen characteristic or characteristics for each SPLOT can be identified. Each characteristic may be given a weight in a SPLOT. For example, when there is a single characteristic such as population, the larger the population is, the greater the weight is, and vice versa. When a delivery point is defined as a single characteristic of a SPLOT, the more the delivery points, the greater the weight is, and vice versa. In these embodiments, when a plurality of SPLOTs having the same size are formed, some of the SPLOTs may include two or more delivery points (higher weight) whereas other SPLOTs include no delivery points (lower or lowest weight). When there are multiple characteristics, each characteristic may be given a particular weight, and the weights may be combined or averaged to provide a weighed score for each SPLOT.

In some embodiments, SPLOTs can be formed based on latitude and longitude values. These SPLOTs can have the same or substantially the same size or similar sizes. In these embodiments, a selected geographical area can be divided into multiple smaller areas having substantially the same or similar latitude and longitude coordinate values. Each of the smaller areas can be a SPLOT. For example, a SPLOT can be sized approximately ⅓ to ½ square miles. In some embodiments, this can be achieved by taking the latitude and longitude of an area having a characteristic and trimming it at the second decimal point of the latitude and longitude. For example, everything with a latitude starting with 37.31 degrees and a latitude ending with 76.54 degrees can be in the same group or geographical area. 0.01 degree of latitude is approximately ⅔ of a mile. 0.01 degree of longitude is widest at the equator at roughly ⅔ of a mile and gradually shrinks to zero at the poles. The above described latitude/longitude values for SPLOTs are merely examples and other latitude/longitude values or ranges thereof can be used to form SPLOTs.

Characteristics of SPLOTs may be determined or identified in many different ways. These characteristics can be used to group, rank or classify SPLOTs, as will be described with regard to step 214 and other steps described hereafter. In some embodiments, a base or main SPLOT (SPLOT 1 in Table 1 below) having a particular characteristic (e.g., including one delivery point) can be selected. Although one main SPLOT is selected in this example, two or more SPLOTs can be selected as main SPLOTs. Furthermore, more than one characteristics described above may be used to classify SPLOTs.

In some embodiments, when the particular characteristic of the main SPLOT is the number of delivery points therein, corresponding characteristics of SPLOTs surrounding the main SPLOT within a predetermined geographic distance can be determined, for example, as shown in Table 1 below. Table 1 demonstrates a geographic arrangement of 9 SPLOTS selected within an area, and is illustrative.

TABLE 1

| | | |
|---|---|---|
| UL1 (SPLOT 3) | Up1 (SPLOT 4) | UR1 (SPLOT 5) |
| Left1 (SPLOT 2) | SPLOT 1 (main SPLOT) | Right1 (SPLOT 6) |
| DL1 (SPLOT 9) | Down1 (SPLOT 8) | DR1 (SPLOT 7) |

In some embodiments, as shown in Table 1, one or more SPLOTs (Left1 or SPLOT 2), on the left side of the main SPLOT, including at least one delivery point, may be identified. Depending on the circumstances, there may be no SPLOT or more than one SPLOT on the left side of the main SPLOT that includes at least one delivery point. Furthermore, since surrounding SPLOTs can be selected within a certain predetermined geographical distance from the main SPLOT, there may be more than one adjacent SPLOTs in each of the eight directions (Left1-DL1). Furthermore, if more than one main SPLOTs used, two or more left side SPLOTs each including at least one delivery point can be identified.

This procedure may repeat in a clockwise direction and sequentially identify SPLOT 3 (UL1) in the upper left side of the main SPLOT, SPLOT 4 (Up1) in the upper side, SPLOT 5 (UR1) in the upper right side, SPLOT 6 (Right1) in the right side, SPLOT 7 (DR1) in the down right side, SPLOT 8 (Down1) in the down side and SPLOT 9 (DL1) in the down left side. In some embodiments, the procedure may repeat in a counterclockwise direction starting from SPLOT 2 and identify SPLOTs 9, 8, 7, 6, 5, 4 and 3 in this order. The starting point may be any of the eight SPLOTs (Left, UL1, Up1, UR1, Right1, DR1, Down1 and DL1). Furthermore, again, once the starting point is determined, a clockwise or counterclockwise direction may be used to identify the remaining surrounding SPLOTs having the predetermined characteristics.

If the procedure continues to expand to surrounding areas, for example, within 1 mile, 2 miles, 3 miles, 4 miles, etc., more surrounding SPLOTs having a particular characteristic (e.g., at least one delivery point) can be identified as shown in Table 2 below. The numbers in Table 2 represent the numbers of SPLOTs identified to have the particular characteristic. Again, these distances (1 mile, 2 miles, 3 miles, 4 miles, . . . ) are merely examples, many other distances (e.g., 2 miles, 4 miles, 6 miles, . . . , or 5 miles, 10 miles, 15 miles, . . . ) can also be used depending on the embodiments or use cases.

TABLE 2

| | | | | | | | Within | Within | Within | |
|---|---|---|---|---|---|---|---|---|---|---|
| SPLOT | Left | UL | Up | UR | Right | . . . | 1 Mile | 2 Miles | 3 Miles | . . . |
| 175 | 250 | 200 | 25 | 2 | 1 | . . . | 1800 | 6000 | 13000 | . . . |

In some embodiments, the characteristic for each SPLOT can be identified quantitatively or on a relative scale. In some embodiments, when one characteristic (e.g., delivery point) is use, each SPLOT can have a weight depending on the level of the characteristic (e.g., the number of delivery points). For example, a SPLOT having no delivery points can be assigned to have weight 0, a SPLOT having one delivery point can be assigned to have weight 1, a SPLOT having two delivery points can be assigned to have weight 2, a SPLOT having three delivery points can be assigned to have weight 3, a SPLOT having four delivery points can be assigned to have weight 4, and a SPLOT having five or more delivery points can be assigned to have weight 5, etc.

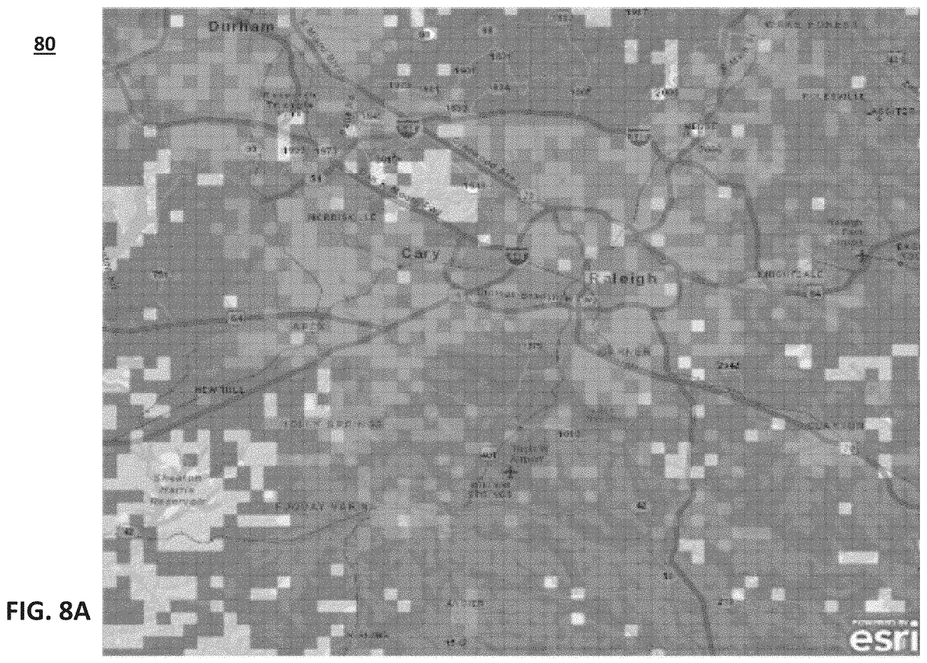

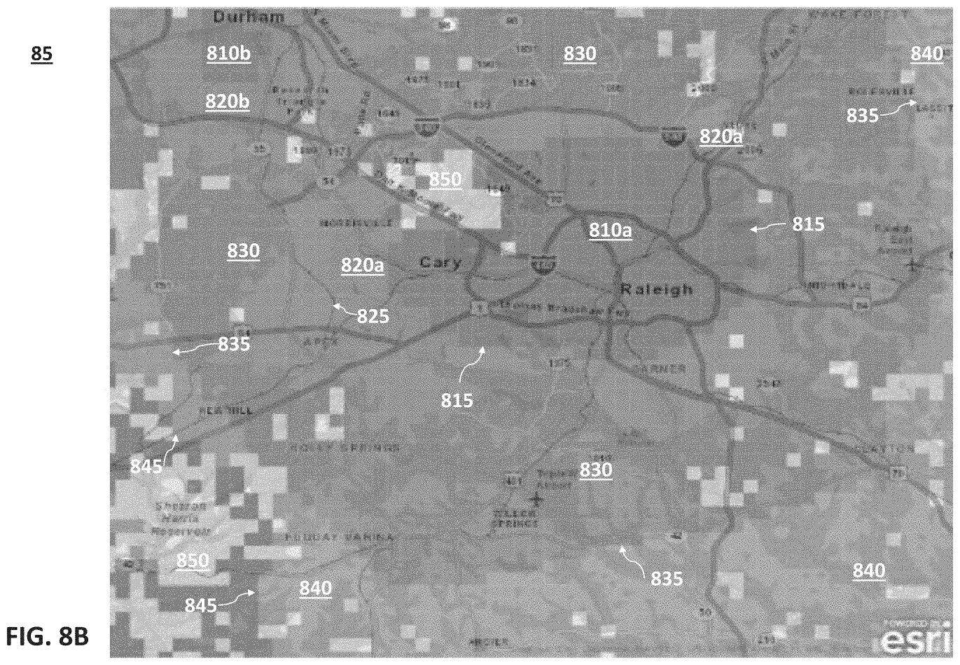

As will be described below with regard to FIG. 8A, a SPLOT map (or computerized or virtual map) 80 is provided to show different groups of SPLOTs in different colors or shadings, and same groups of SPLOTs in the same colors or shadings depending on the weights of SPLOTs (e.g., numbers of delivery points) so that the same groups of SPLOTs can be visually identified as such and the different groups of SPLOTs can be represented to be visually distinguished from each other on the SPLOT map, for example, via color, shading, shape, etc.

In some embodiments where there are more than one characteristics (a population density, a mail volume per population, a mail volume per land area, the number of businesses, etc.), a weight can be given to each characteristic, and the weights may be combined or averaged to provide a weighted score for each SPLOT. A SPLOT map 85 is shown in FIG. 8B to show different groups of SPLOTs in different colors or shadings, and the same groups of SPLOTs in the same colors or shadings depending on the weighted scores of SPLOTs (e.g., combined or averaged weights of multiple characteristics) so that the same groups of SPLOTs can be visually identified as such on the SPLOT map and the different groups of SPLOTs can be represented to be visually distinguished from each other, for example, via color, shading, shape, etc. This will be described in greater detail below.

In state 214, SPLOTs that have been formed and whose characteristics have been identified can be ranked. In some embodiments, SPLOTs can be ranked based on one or more of SPLOT characteristics discussed above such as a population density, the number and volume of items, such as priority mail, same day, overnight, etc. volumes, an item volume per population, an item volume per land area, the number of businesses, the number of residential buildings, the number of vacant buildings, customer behavior, business partner behavior patterns, the number of addresses, the number of primary business partners per population, and the number of primary business partners per land area. For example, when the characteristic relates to population, SPLOTs can be divided based on the degree of population density. For example, the ranking can include the most dense area (hereinafter to be interchangeably used with “urban extreme”), a second most dense area (hereinafter to be interchangeably used with “urban major”), a third most dense area (hereinafter to be interchangeably used with “urban suburb”), a middle area (hereinafter to be interchangeably used with “urban small city”), a third least dense area (hereinafter to be interchangeably used with “rural target”), a second least dense area (hereinafter to be interchangeably used with “rural”) and the least dense area (hereinafter to be interchangeably used with “most rural”). Although seven groups are provided in the population ranking, there can be more or less than seven groups. Ranking for other characteristics can also be determined in a similar manner described above with respect to population.

In some embodiments, ranking can be made according to weighted scores calculated based on one or more of the above descried SPLOT characteristics (a population density, the number of priority mail 1 day services and volumes, a mail volume per population, a mail volume per land area, the number of businesses, the number of residential buildings, the number of vacant buildings, customer behavior, business partner behavior patterns, the number of addresses, the number of primary business partners per population, and the number of primary business partners per land area). For example, each characteristic may be given a weight per a SPLOT. The weights may be combined or averaged for the SPLOT, and ranking can be given based on the weighted scores.

In state 216, once one geographical area is completed with forming SPLOTs, a SPLOT forming procedure may be expanded to another geographical area, for example, adjacent geographical areas. SPLOT forming and ranking can be done in those adjacent geographical areas in the same way described above.

The cluster forming procedure 220 includes states for grouping ranked SPLOTs 222 and forming clusters of SPLOTs 224. In state 222, SPLOTs that have been ranked in state 214 may be grouped accordingly to form clusters. In some embodiments, SPLOTs having the same ranking can be grouped together. For example, a group of SPLOTs in multiple local areas that have been ranked as the most dense area can be grouped together. Furthermore, a group of SPLOTs in the multiple local areas that have been ranked as the least dense area can be grouped together. Similarly, a group of SPLOTs in the multiple local areas that have been ranked as the intermediate area can be grouped together.

In some embodiments, SPLOTs having similar rankings can be grouped together. For example, a group of SPLOTs in multiple local areas that have been ranked as the most dense area and second most dense area can be grouped together as a most dense SPLOT group. Furthermore, a group of SPLOTs in multiple local areas that have been ranked as the third most dense area, the middle area, the third least dense area can be grouped together as a medium-dense SPLOT group. Furthermore, a group of SPLOTs in the multiple local areas that have been ranked as the second least dense area and the least dense area can be grouped together as a least dense SPLOT group. These methods of grouping are merely examples and other grouping methods are also possible. In some embodiments, SPLOTs are only grouped if they share one border. If two SPLOTs are not adjacent, or if they do not share at least one border, they are not grouped. In some embodiments, SPLOTs are only grouped if they share two or more borders. In some embodiments, SPLOTs can be grouped if they are near another SPLOT but do not share a border. In this case, two SPLOTs can be grouped if there is only a single SPLOT between the two SPLOTs, if there are two SPLOTs therebetween, etc. In some embodiments, the SPLOT between the two SPLOTs can be grouped with the adjacent SPLOTs who share the same rankings. In some embodiments, SPLOTs that share a point, that is, if the corners touch, these SPLOTs can be grouped.

In state 224, clusters of SPLOTs may be formed. A cluster of SPLOTs may be defined as a group of SPLOTs having the same or similar characteristics. Depending on the size of the geographical area that was used to form SPLOTs, a cluster may include only a group of SPLOTs within the geographical area or can also include another group(s) of SPLOTs in other geographical areas that have the same or similar characteristics. In the above population example, the most dense SPLOT group can form a first cluster, the medium-dense SPLOT group can form a second cluster and the least dense SPLOT group can form a third cluster. In the above example, factors other than population can be used. In some embodiments, if two or more SPLOT groups are geographically close to each other, even if they belong to other groups, those SPLOT groups can form the same cluster. For example, if some of the SPLOTs of the third most dense group are closer to the first cluster to be formed than the second cluster to be formed, those SPLOTs can be part of the first cluster instead of the second cluster. Similarly, if other SPLOTs of the third most dense group are closer to the third cluster to be formed than the second cluster to be formed, those SPLOTs can be part of the third cluster instead of the second cluster.

In some embodiments, if two or more SPLOT groups are more similar to each other than adjacent SPLOT groups, even if they belong to other groups, those SPLOT groups can form the same cluster. For example, if some of the SPLOTs of the third most dense group are more similar to the first cluster to be formed than the second cluster to be formed, those SPLOTs can be part of the first cluster instead of the second cluster. Similarly, if other SPLOTs of the third most dense group are more similar to the third cluster to be formed than the second cluster to be formed, those SPLOTs can be part of the third cluster instead of the second cluster. Many parameters can be used to determine whether SPLOT groups are similar to each other. Some embodiments determine similarity based on one or more of the above described factors or characteristics, including, but not limited to, a population density, the number of priority mail 1 day services and volumes, a mail volume per population, a mail volume per land area, the number of businesses, the number of residential buildings, the number of vacant buildings, customer behavior, business partner behavior patterns, the number of addresses, the number of primary business partners per population, and the number of primary business partners per land area. For example, by using information from the current SPLOT and surrounding areas, similar SPLOTs can be ranked and grouped together into a particular cluster.

In some embodiments, one geographical area (e.g., town, city, county, state, whole country, etc.) can include one or more clusters. For example, one geographical area can include an urban cluster and a rural cluster. In another example, one geographical area can include two or more of an urban cluster, a suburban cluster and a rural cluster. In another example, one geographical area can include only one of an urban cluster, a suburban cluster or a rural cluster.

The SPLOTs/clusters managing procedure 230 may include states for updating SPLOTs ranking over time 232 and updating clusters over time 234. In state 232, SPLOT ranking may be updated over time. For example, a first ranking may be given to each of the SPLOTs in a given cluster based on the weighted scores at a first point of time. Furthermore, a second ranking may be given to each of the SPLOTs based on the weighted scores at a second point of time later than the first point of time. The first and second rankings may be compared and if they are different in a given SPLOT, a ranking may be updated to the particular SPLOT. In some embodiments, these ranking changes in the local areas can be used, for example, in determining/predicting changes in number of delivery points, forecasting item volumes at each local area and rolling this up to Zip Code and determining patterns at a lower level than Zip Code (to be described in more detail below).

In state 234, clusters can be updated over time based on whether SPLOTs located in a cluster are updated. For example, some SPLOTs that initially belonged to a cluster number one may be updated in ranking such that one or more of those SPLOTs now belong to a cluster number two whereas the remaining SPLOTs that maintained the same ranking may not be updated. In some embodiments, all of SPLOTs that initially belonged to a particular cluster may be updated in ranking such that all of them now belong to another different cluster.

The procedure 240 relating to use cases includes states using SPLOTs and updated SPLOTs in different areas 242 and using clusters and updated clusters in different areas 244.

In state 242, some embodiments keep track of changes in SPLOTs over time regarding different characteristics described above to determine potential use cases. For example, changes in characteristics (e.g., population density) in SPLOTs may be used to determine and/or predict changes in number of delivery points and types. SPLOT changes may also be used to forecast item volumes at SPLOT levels and roll this up to Zip Code. They may also be used to determine patterns at a lower or smaller level than a Zip Code. Changes in SPLOTs may further be used to create models to determine the value of delivery points relative to each other, for example, by making smaller sizes of SPLOTs in highly valuable areas that have relatively more delivery points. SPLOT changes can also be used to predict areas that will see vacancies go up, forecast new areas of development, areas of decline, use it to model geographic customer behavior or use it to measure service relative to each other. In some embodiments, SPLOT attributes and forcasting may be sold to a third party to determine the value of SPLOT level data. For example, they can be used to determine whether this level of data is valuable and marketable to other companies or whether others will purchase and use this data in a manner similar to what the census data currently provides.

Other potential use cases may include determining competitors' behaviors and package volumes, developing new delivery pricing agreement, breaking up an area in a way other than by ZIP Code, estimating competitors' delivery costs, drawing arbitrary boundary contemplated or estimated by competitors. Furthermore, sorting items based on SPLOTs/clusters may provide insights as to whether a particular graphical area has been changed, for example, a new highway built, a new apartment complex built, etc. SPLOT level analysis may also determine whether a delivery route may need to be changed for faster or more efficient delivery. SPLOT level analysis may further be used to determine whether regions (e.g., municipal) in a city, town, village, or other area need to be redrawn, for example, for tax levying purpose or electrical district drawing, etc. Moreover, SPLOT level analysis may be used to identify any changes in neighborhood, for example, to determine what happened to a certain SPLOT when less or more packages are delivered to the particular SPLOT compared to surrounding SPLOTs.

Instate 244, some embodiments keep track of changes in characteristics of clusters over time to determine potential use cases, use and update clusters in many different areas as described above with respect to state 242. Again, as described above, a cluster may be partially updated due to only portions of SPLOTs having changed their ranking, or the entire cluster may be updated to another different cluster due to all or a majority of constituent SPLOTs having changed their ranking.

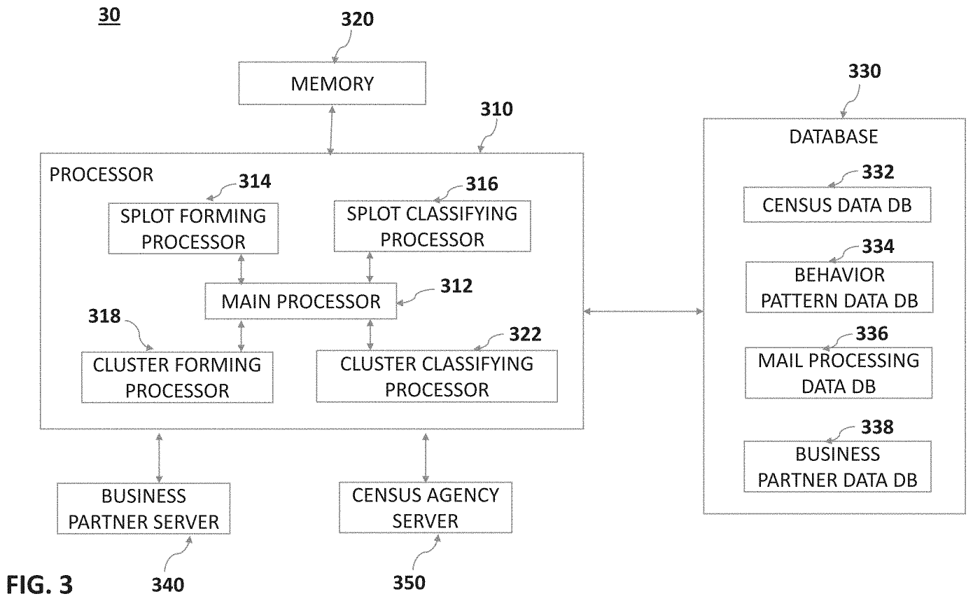

FIG. 3 illustrates a block diagram of a system 30 for electronically forming, clustering and managing a plurality of SPLOTS according to some embodiments. The system 30 may include a processor 310, a memory 320 and a database 330. The memory 320 may be a working memory to be used by the processor 310 while the processor 310 executes instructions and/or processes relevant data. In some embodiments, the processor 310 may communicate data with a business partner server 340 and a census agency server 350. In some embodiments, the database 330 may store data provided by the business partner server 340 and the census agency server 350. The business partner server 340 may be operated by delivery entities, autonomous delivery trucking companies or any other entity that can deliver items. The census agency server 350 may be operated by a government (state or federal) agency that maintains census data. The system 30 shown in FIG. 3 is merely an example processing system, and certain elements may be modified or removed, and/or other elements or equipment may be added.

The processor 310 may include a main processor 312, a SPLOT forming processor 314, a SPLOT classifying processor 316, a cluster forming processor 318 and a cluster classifying processor 322. The main processor 312 may coordinate and/or control operations of the surrounding processors 314-318 and 322. The main processor 312 may be configured to incorporate the functions of one or more of the processors 314-318 and 322. These processors may be embodied as a single processor operating one or more utilities, applications, modules, etc.

The SPLOT forming processor 314 may be configured to form SPLOTs, for example, based on the procedures described with respect to FIG. 2. The SPLOT classifying processor 316 may be configured to classify SPLOTs that have been formed by the SPLOT forming processor 314, for example, based on procedures described with respect to FIG. 2. The SPLOT forming processor 314 and the SPLOT classifying processor 316 may be combined into a single processor.

The cluster forming processor 318 may be configured to form clusters, for example, based on procedures described with respect to FIG. 2. The cluster classifying processor 322 may be configured to classify clusters that have been formed by the cluster forming processor 318, for example, based on procedures described with respect to FIG. 2. The cluster forming processor 318 and the cluster classifying processor 322 may be combined into a single processor. Furthermore, the SPLOT forming processor 314 and the cluster forming processor 318 may be combined into a single processor. Moreover, the SPLOT classifying processor 316 and the cluster classifying processor 322 may be combined into a single processor.

The database 330 may include a census data DB 332, a behavior pattern data DB 334, a mail processing data DB 336 and a business partner data DB 338. Again, the database 330 is merely an example DB and can include additional DBs. Furthermore, two or more of the DBs 332-338 may be combined into a single DB or at least one of the DBs 332-338 may be separated into two or more DBs.

The census data DB 332 may store census data. The census data DB 332 may be updated based on data directly received from the census agency server 350 or indirectly via the main processor 312. Census data may include, but not limited to, a population density, the number of businesses, the number of residential buildings, the number of addresses, the number of primary business partners per population, the number of primary business partners per land area, P.O. Box count, mortgage, delivery point location, property land value, delivery point type, home value, household income, or other census information provided by the census agency server 350 or other census data maintaining agency.

The behavior pattern data DB 334 may store behavior pattern data showing different behavior sets of data for different entities such as delivery entities or autonomous delivery trucking companies, etc. In some embodiments, the behavior pattern data DB 334 may be updated based on data directly received from the business partner server 340 or indirectly via the main processor 312. The behavior pattern data may include, for example, customer behavior patterns and/or business partner behavior patterns.

The mail processing data DB 336 may store data relating to mail processing such as mail delivery to particular areas or ZIP Codes, etc. The mail processing data may include, for example, one or more of the number of priority mail 1 day services and volumes, a mail volume per population and a mail volume per land area.

The business partner data DB 338 may store data relating to business partners. The business partner data DB 338 may be updated based on data directly received from the business partner server 340 or indirectly via the main processor 312. For example, assuming that the USPS operates the system 30, when some business partners terminate a business relationship with the USPS, those business partner information may be removed from the business partner data DB 338. As another example, when a new business partner is added, the new entity can be added to the business partner data DB 338.

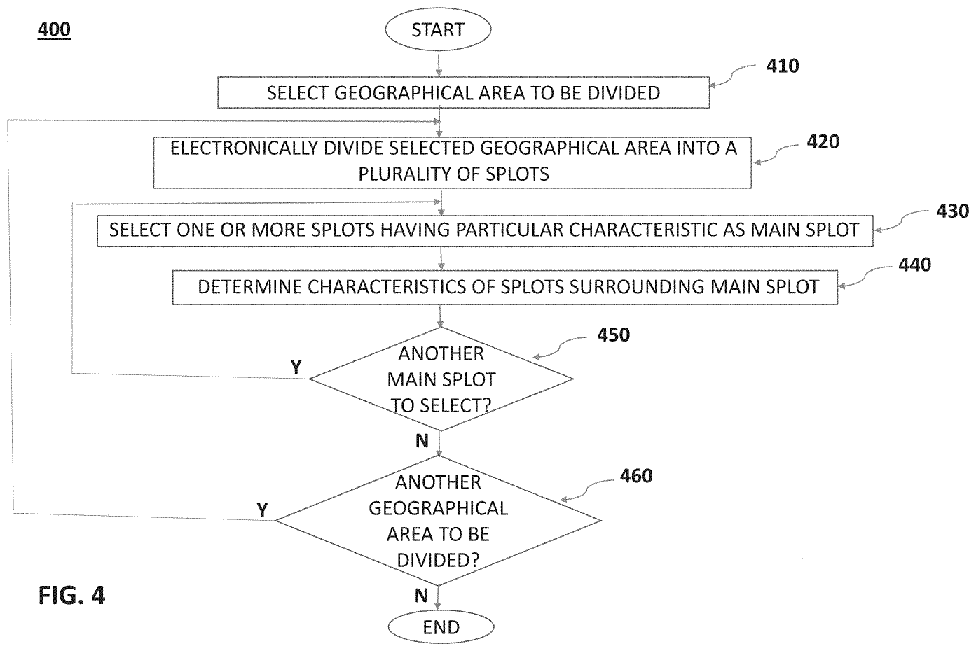

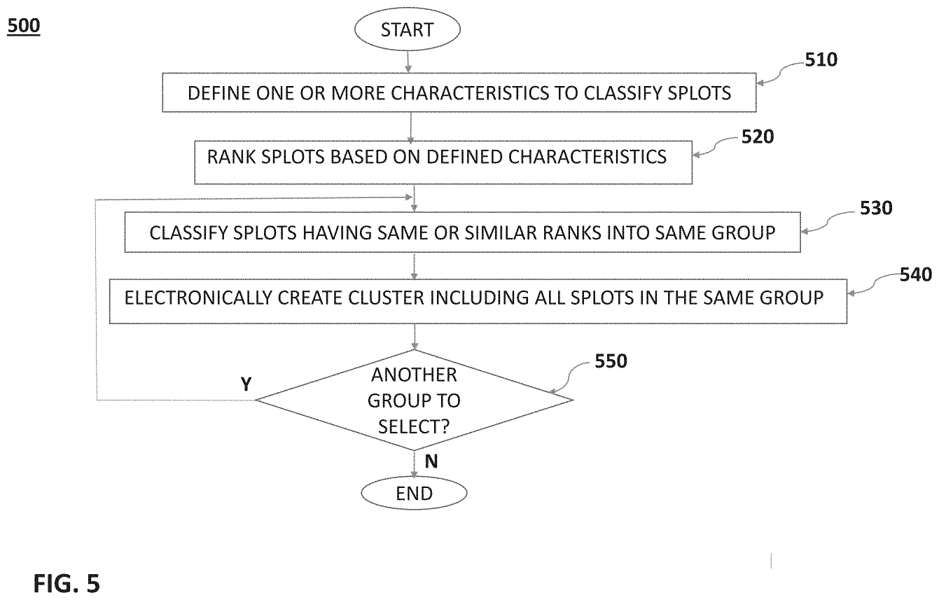

FIG. 4 illustrates a process flow diagram 400 of a method for electronically forming SPLOTs according to some embodiments. In some embodiments, the process flow diagram 400 may be performed by the components of FIG. 3. In some embodiments, the process flow diagram 400 may be performed by one or more of the SPLOT forming processor 314 and the SPLOT classifying processor 316. For the purpose of convenience, a description will be provided based on the processor 310 performing the process flow diagram 400. Although the process flow diagram 400 is described herein with reference to a particular order, in various embodiments, states herein may be performed in a different order, or omitted, and additional states may be added. This may apply to the process flow diagrams 500-700 shown in FIGS. 5-7.

In state 410, the processor 310 may select a geographical area to be divided into a plurality of SPLOTs. The geographical area may be as large as town, city, county, state or an entire country. The geographical area may be the same or smaller in size than a ZIP Code area.

In state 420, the processor 310 may electronically divide the selected geographical area into a plurality of SPLOTs using, for example, one of the procedures discussed above with respect to FIGS. 2 and 3. As described above, each SPLOT can be smaller in size than a ZIP Code area.

In state 430, the processor 310 may select one or more SPLOTs having a particular characteristic (described above with respect to FIG. 2) as a main SPLOT. In state 440, the processor 310 may determine or identify characteristics of SPLOTs surrounding or adjacent to the main SPLOT, for example, using the procedures described above with respect to FIG. 2. In state 450, the processor 310 may determine whether there is another main SPLOT to select. If the processor 310 determines in state 450 that there is an additional main SPLOT to select, the processor 310 may repeat the states 430-450. An additional main SPLOT may be selected if, for example, more than one of the SPLOTs within the geographic area have a particular characteristic, meet a determined threshold for a characteristic and the like. If two SPLOTs have high values of the particular characteristic and are geographically separated by a determined distance, then two main SPLOTs may be selected and used to generate clusters as described elsewhere herein. The geographic separation between the two main SPLOTs can be set to a distance, number of SPLOTs, or other characteristics. If two main SPLOTs are near one another, they may be best determined as a single cluster, and not as two separate, adjacent clusters. In some embodiments, by using a threshold distance, two main SPLOTs will not be selected to be geographically too near one another.

If the processor 310 determines in state 450 that there is no additional main SPLOT to select, the processor 310 may determine whether there is an additional geographical area to be divided into a plurality of SPLOTs (state 460). If the processor 310 determines in state 460 that there is an additional geographical area to be divided into a plurality of SPLOTs, the processor 310 may repeat the states 420-460. If the processor 310 determines instate 460 that there is no additional geographical area to be divided into a plurality of SPLOTs, the processor 310 may end the procedure 400.

In some embodiments, state 450 may be omitted. In these embodiments, the main SPLOT may be selected only once and surrounding SPLOTs can be expanded from the selected single main SPLOT.

FIG. 5 illustrates a process flow diagram of a method 500 for electronically clustering SPLOTs that have been formed in FIG. 4 according to some embodiments. The method 500 may be performed by the components of FIG. 3, such as the process or 310 and/or one or more of the cluster forming processor 318 and the cluster classifying processor 322. For the purpose of convenience, a description will be provided based on the processor 310 performing the process flow diagram 500.

In state 510, the processor 310 may define one or more characteristics to classify SPLOTs that have been created. For example, as discussed above, the characteristics can be the number of retail stores, schools, government offices, and delivery points, etc. The SPLOT characteristics can be similar to those described elsewhere herein.

In state 520, the processor 310 may rank SPLOTs based on the defined characteristics. For example, when a population density is defined as the characteristic, the more dense the population of a SPLOT is, the higher the rank is, and vice versa. The ranking can include at least two rankings, for example, a dense area or a sparse area. The ranking can also include three or more rankings, for example, the most dense area, an intermediate area, or the least dense area, etc. Furthermore, as discussed above, the population density ranking can include seven or more rankings.

In some embodiments, when there are more than one characteristics, each characteristic can have a predetermined weight. The weight may be the same or different for each of the characteristics. For example, when the number of delivery points, population and the number of retail stores are selected as three characteristics, all of them may have the same weight. Alternatively, some characteristics may have a higher or lower weight than others. In these embodiments, the processor 310 may rank SPLOTs based on, for example, the total scores of the weights of the characteristics or an average of the total scores of the weights of the characteristics.

In state 530, the processor 310 may classify SPLOTs having the same or similar ranks into the same group. For example, when the population density includes seven rankings, the most and second most dense SPLOTs (e.g., “urban extreme” and “urban major” SPLOT groups), can be one group, the least and second least dense SPLOTs (e.g., “rural” and “most rural” SPLOT groups) can be another group, and the remaining SPLOTs (e.g., “urban suburb,” “urban small city” and “rural target” SPLOT groups) can be the last group. In some embodiments, the most dense SPLOT (e.g., “urban extreme” SPLOT group) can be one group, the least dense SPLOT (“most rural” SPLOT group) can be another group and the middle five SPLOTs (e.g., “urban major,” “urban suburb,” “urban small city,” “rural target” and “rural” SPLOT groups) can be the last group. When there are seven or more rankings in SPLOTs, there may be the same number of SPLOT groups to be divided.

In state 540, the processor 310 may electronically create a cluster including all SPLOTs in the same group. In some embodiments, the cluster may include a group of SPLOTs that are neighboring each other. In some embodiments, the cluster may include a group of SPLOTs at least some of which are not neighboring each other. Each cluster can be indicated or represented to be visually distinguishable from each other on a SPLOT map, for example, different colors, different shapes, different shadings, a combination thereof, etc., as described with respect to FIGS. 8A and 8B.

In state 550, the processor 310 may determine whether there is an additional group or groups to be selected as another cluster. If the processor 310 determines instate 550 that there is an additional group or groups to be selected as another cluster, the processor 310 may repeat the states 530-550. An additional group may be identified, for example, if there is another SPLOT meeting or having the defined characteristics located within the geographic area which is separated from another SPLOT or group by a distance, a number of SPLOTs, or some other criteria. If the processor 310 determines in state 550 that there is no additional group to select, the processor 310 may end the method 500.

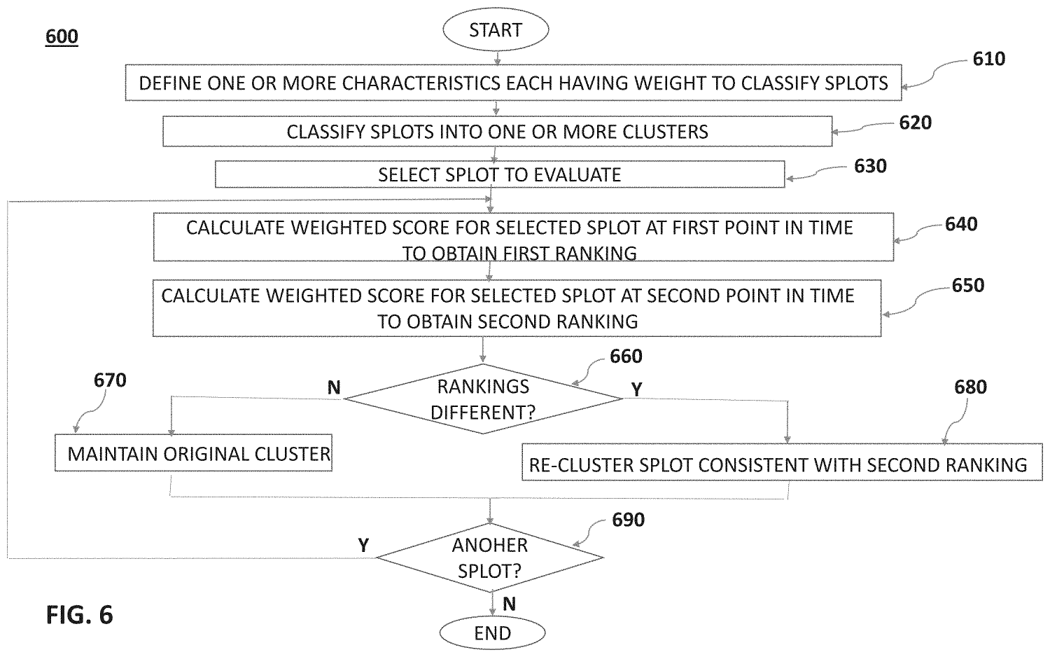

FIG. 6 illustrates a process flow diagram of a method 600 for evaluating SPLOT clusters over time according to some embodiments. The method 600 may be performed by the components of FIG. 3.

In state 610, the processor 310 may define one or more characteristics each having a weight to classify SPLOTs into a cluster or clusters. In state 620, the processor 310 may classify SPLOTs into clusters as described above with respect to FIG. 5. In state 630, the processor 310 may select a SPLOT to evaluate. The selected SPLOT may belong to a cluster (e.g., original cluster).

In state 640, the processor 310 may calculate a weighted score for the selected SPLOT at a first point of time to obtain a first ranking. For example, as discussed above, the one or more characteristics may be associated with a weight. If multiple characteristics are assigned to the selected SPLOT, the sum of the weights of the multiple characteristics can be used as the weighted score. In some embodiments, the higher the weighted score is, the higher the first ranking is. In some embodiments, the higher the weighted score is, the lower the first ranking is.

In state 650, the processor 310 may calculate a weighted score for the selected SPLOT at a second point of time, different from the first point of time, to obtain second ranking. For example, when the first ranking is obtained at a time T1, the second ranking may be obtained at a time T2 which is later than T1, for example, 1 month, 6 months, 1 year or 3 years later, etc. In some embodiments, when a certain number of characteristics are used for the first ranking, the same characteristics may be used for the second ranking.

In state 660, the processor 310 may compare the first and second rankings to determine whether they are different from each other. In some embodiments, the first ranking of the selected SPLOT obtained at T1 can be lower or higher than the second ranking of the selected SPLOT obtained at T2. In some embodiments, the first ranking of the selected SPLOT at T1 can be the same as the second ranking of the selected SPLOT at T2.

When the processor 310 determines in state 660 that the first ranking and the second ranking are not different from each other (i.e., the same ranking at T1 and T2), the processor 310 may maintain the original cluster to which the selected SPLOT originally belonged (state 670). When the processor 310 determines in state 660 that the first ranking and the second ranking are different from each other, the processor 310 may re-cluster the selected SPLOT to be consistent with the second ranking so that the SPLOT now belongs to another different (new) cluster (state 680). For example, the selected SPLOT may be moved from the original cluster (e.g., urban extreme) to the new cluster (e.g., urban major) and may be represented accordingly in the SPLOT map. In some embodiments, where the selected SPLOT was a main SPLOT, that is, was used to generate a cluster at T1, if the SPLOT at T2 has a different ranking, the processor 310 can evaluate the SPLOTs surrounding the selected SPLOT to determine whether the grouping or cluster should be re-evaluated. In some embodiments, the processor 310 can repeat the processes described with regard to FIGS. 4-5 when the rankings at T1 and T2 are different.

Instate 690, the processor 310 may determine whether there is another SPLOT to be evaluated. In some embodiments, this can occur if there is another cluster within a geographic area being evaluated, or if there is another SPLOT that was determined to be a main SPLOT previously within the geographic area. If the processor 310 determines instate 690 that there is an additional SPLOT to be evaluated, the processor 310 repeats the states 640-690. If the processor 310 determines in state 690 that there is no additional SPLOT to be evaluated, the processor 310 may end the method 600.

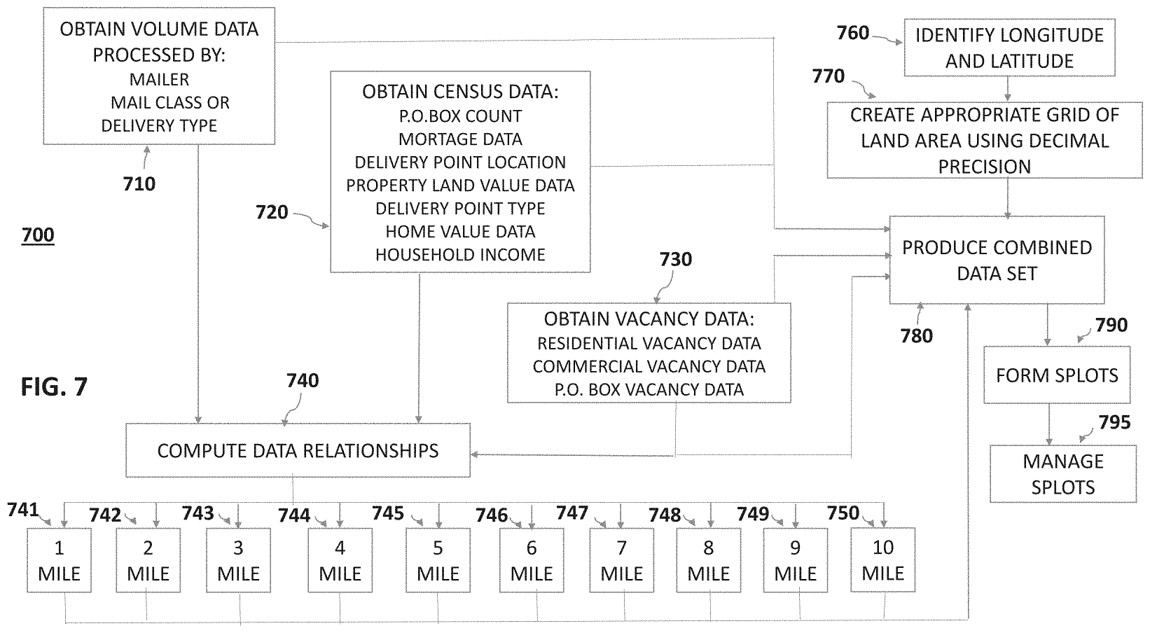

FIG. 7 illustrates a process flow diagram 700 of a method for electronically forming SPLOTs within the USPS according to some embodiments. Although described with regard to the USPS and information available to the USPS, the processes of FIG. 7 can be applicable to contexts other than the USPS without departing from the scope of this disclosure. The process flow diagram 700 may be performed by the components of FIG. 3.

In state 710, the processor 310 may obtain mail volume data. Examples of the mail volume data include, but are not limited to, data relating to or processed by mailers, mail class and/or delivery type, the number of mail items, parcels, etc. to be delivered to a selected geographic area. The mail volume data may additionally include the number of priority mail one-day services and volumes, a mail volume per population, and a mail volume per land area. In some embodiments, the processor 310 may obtain such volume data from the mail processing data DB 336 shown in FIG. 3. These are merely exemplary mail volume data, and other volume data can also be considered.

In state 720, the processor 310 may obtain census data. Examples of the census data include, but are not limited to, data relating to P.O. Box count, mortgages, occupancy, delivery point location, property land value, delivery point type, home value, or household income. In some embodiments, the processor 310 may obtain such census data from the census data DB 332 and the mail processing data DB 336 shown in FIG. 3. These are merely example census data, and other census data can also be considered.

In state 730, the processor 310 may obtain vacancy data. Examples of the vacancy data include, but are not limited to, data relating to vacant delivery points, residential vacancy, commercial vacancy and P.O. Box vacancy. The residential vacancy data, commercial vacancy data and P.O. Box vacancy data may be obtained, for example, from the vacant delivery point data. In some embodiments, the processor 310 may obtain such vacancy data from the census data DB 332 and the mail processing data DB 336 shown in FIG. 3. These are merely example vacancy data, and other vacancy data can also be considered.

In state 740, the processor 310 may compute relationships among the obtained volume data, census data and vacancy data. For example, some of the volume data (mailer, mail class or delivery type) may be related to one or more census data examples (P.O. Box count, mortgage, delivery point location, property land value, delivery point type, home value, or household income) and/or some of the vacancy data examples (vacant delivery points, residential vacancy, commercial vacancy and P.O. Box vacancy). Although not shown in FIG. 7, the processor 310 may also consider customers' and/or competitors' (or business partners') behavior pattern data described above with respect to FIG. 3 in computing the data relationships. Furthermore, the processor 310 may also consider SPLOT characteristics, in computing the data relationships, discussed above such as a population density, the number of priority mail one-day services and volumes, a mail volume per population, a mail volume per land area, the number of businesses, the number of residential buildings, the number of vacant buildings, customer behavior, business partner behavior patterns, the number of addresses, the number of primary business partners per population, and the number of primary business partners per land area.

The processor 310 may compute the data relationships, for example, within one mile, two miles, . . . , ten miles (states 741-750) from a certain geographical point (e.g., a main SPLOT described above). For example, the processor 310 may compute the data relationships among the volume data, census data and vacancy data for a region within 1 mile from the geographical point and store the computed data in a memory. Thereafter, the processor 310 may compute the data relationships among the volume data, census data and vacancy data for a region within 2 miles from the geographical point and store the computed data in the memory. The processor 310 may continue to compute the data relationships for regions within 3 miles, 4 miles, . . . , 10 miles, and store the computed data in the memory.

1 mile-10 miles are merely examples, and the processor 310 may consider other distance arrangement such as 0.5 mile increment (0.5-5 miles, or 0.5-2.5 mils), 2 mile increment (e.g., 2-20 miles, or 2-10 miles), 5 mile increment (e.g., 5-50 miles, or 5-25 miles), etc. The processor 310 may also consider less or more than 10 increments, for example, 1 mile increment five times (1-5 mils), 1 mile increment twenty times (e.g., 1-20 miles, or 1 mile increment one hundred times (1-100 miles), etc. Other distances for states 741-750 can be used without departing from the scope of the current disclosure.

In state 760, the processor 310 may identify the longitude and latitude coordinate values of a geographical area to be divided to a plurality of SPLOTs. In state 770, the processor 310 may create an appropriate grid of the geographical area using decimal precision, for example, using the procedure described with respect to FIG. 2.

In state 780, the processor 310 may produce a combined data set for forming SPLOTs. The combined data set may include the volume data (obtained in state 710), the census data (obtained in state 720), the vacancy data (obtained in state 730), the data relationships for 1-10 miles (obtained in states 740-750) and the grid information (created in state 770). The data and relationships obtained in states 710-770 can be performed in parallel, simultaneously, substantially simultaneously, or at different times. For example, census data, volume data and vacancy data can all be gathered in parallel, and at the same or different times as identifying longitude and latitude, or all can be performed at different times or at the same time. Each of the data flows is combined in state 780 to produce a combined data set.

Instate 780, the processor 310 can, for example, assign volume data, census data and vacancy data into the grid of land area. The volume data, census data, vacancy data, and the like for delivery points which fall within a grid segment, will be compiled, and scores or rankings will be assigned to the SPLOT based on the volume data, census data, and vacancy data.

In state 790, the processor 310 may form SPLOTs based on the combined data set produced in state 780. In some embodiments, the size of a SPLOT can correspond to the grid of the land area from state 770. In some embodiments, a SPLOT may require a minimum number of delivery points, a minimum mail volume, population, etc. in order to be formed. The processor 310 may evaluate a grid and its associated data to determine whether a threshold is met for forming a SPLOT. If a single grid does not meet the threshold, the processor 310 can evaluate a neighboring grid area based on the data for that grid area. If two adjacent grid areas meet the threshold requirements for forming a SPLOT, the processor 310 can determine that the adjacent grid areas are a SPLOT. In some embodiments, two or more adjacent grid areas may be combined to form a SPLOT. In some embodiments, SPLOT sizes may vary in different geographic areas. For example, in a rural area, SPLOTs on the average, may encompass more land area than SPLOTs in suburban or urban areas. In some embodiments, SPLOTs within the same geographic area may encompass different land areas.

In some embodiments, the processor 310 can determine in state 780 SPLOTs and corresponding clusters (using exemplary methods in FIGS. 4-6), based on selected characteristics or criteria. For example, the processor 310 can produce a SPLOT map and SPLOT clusters based only on population or item volume. The processor 310 can generate another SPLOT map and SPLOT clusters using another criterion, such as number of delivery points. The processor 310 can generate SPLOT maps and SPLOT clusters according to any desired characteristic or combination of characteristics, as desired. In some embodiments, for example, where there are more than one characteristics (population density, a mail volume per population, a mail volume per land area, the number of businesses, etc.), a weight can be given to each characteristic, and the weights may be combined or averaged to provide a weighted score for each SPLOT to generate a SPLOT map and SPLOT clusters based on a plurality of characteristics.

In state 795, the processor 301 may manage SPLOTs including classifying and grouping, for example, using one or more procedures described above with respect to FIGS. 2 and 4-6.

When SPLOTs have been clustered and organized, as depicted, for example in FIGS. 8A and 8B, the distribution network, such as the USPS, can use the clustered SPLOTs in assessing routes, carrier performance, pricing, delivery schedules, delivery guarantees. For example, transportation or delivery of an item from one cluster to another cluster can be a first price and have a first time delivery guarantee, and delivery of an item between other clusters can be a second price, and have a second time delivery guarantee. In some embodiments, when a cluster is created or modified, the system can evaluate routes of delivery carriers, of schedules of processing equipment, run time, sort plans, and the like, and optimize or change the same based on the clustering.

As noted above, FIG. 8A depicts an exemplary SPLOT map (or computerized or virtual map) 80 and shows different groups of SPLOTs in different colors or shadings, and same groups of SPLOTs in the same colors or shadings depending on the weights of SPLOTs (e.g., numbers of delivery points) so that the same groups of SPLOTs can be visually identified as such and the different groups of SPLOTs can be represented to be visually distinguished from each other on the SPLOT map, for example, via color, shading, shape, etc. In a SPLOT map, the darker areas can represent SPLOTs having lower rankings for selected characteristics. In FIG. 8A specifically, the darker areas represent areas with relatively lower numbers of delivery points and lower populations. The lighter areas represent areas with relatively higher number of delivery points and populations. The lightest or unshaded regions can identify SPLOTs having no or very little population, and may correspond, for example, to bodies of water, mountains, national or state parks, preserves, etc. FIG. 8A can represent the raw SPLOT data generated, for example, before SPLOTs are grouped or clustered as described herein.

FIG. 8B is an exemplary SPLOT map 85 showing SPLOT clusters formed from the SPLOT data in FIG. 8A. Using the SPLOT data form SPLOT map 80, and using a 25 mile radius from the central point in the map, SPLOTs are clustered in different colors or shadings, and the same groups of SPLOTs in the same colors or shadings depending on the weighted scores of SPLOTs (e.g., combined or averaged weights of multiple characteristics) so that the same groups of SPLOTs can be visually identified as such on the SPLOT map and the different groups of SPLOTs can be represented to be visually distinguished from each other, for example, via color, shading, shape, etc.

A first cluster 810a is identified from the raw SPLOT map 80. The first cluster 810a cluster is formed using the processes described herein, and meets certain criteria, for example population criteria. The first cluster 810a identifies an area having a relatively higher number of delivery points in and around the city of Raleigh, N.C. The first cluster 810a has a boundary 815a, marked by a change in shading on FIG. 8B. A second cluster 820a is located at regions farther from the center of the first cluster 810a, and indicates a group of SPLOTs having a relatively lower number of delivery points than the SPLOTs of the first cluster 810a. The second cluster 820a has a boundary 825 encompassing the SPLOTs of the second cluster 820a, and indicated by a change in the shading of the SPLOTS. A third cluster 830 and a fourth cluster 840 are also identified, each having a progressively lower number of delivery points than the first and second clusters 810a and 820a. The third cluster 830 and the fourth cluster 840 are bounded by boundaries 835 and 845 respectively.

The map 85 also shows un-clustered areas 850. These areas may have insignificant numbers of delivery points, or may have no delivery points at all.

The map 85 also shows an alternate first cluster 810b and an alternate second cluster 820b centered around the city of Durham, N.C. The alternate first cluster 810b was formed having a first cluster designation because it has the relatively highest number of delivery points, but is located at a distance from the first cluster around Raleigh, and had sufficient numbers of intervening SPLOTs having relatively lower numbers of delivery points. Thus, the processor 310 identified the alternate first and second clusters 810b and 820b. The alternate first and second clusters 810b and 820b are alternate in the sense that they occurred within the same geographic area being analyzed, and were relatively smaller than first cluster 810a and second cluster 820a. To illustrate, if the geographic area being analyzed was centered around Durham N.C., or if the area being analyzed was smaller, the alternate first cluster 810b would be the only first cluster in the map 85.

These first, second, third, and fourth clusters depicted on the map 85 can be used for a variety of reasons within a distribution network, including identifying resources, logistics planning, evaluating delivery routes, pricing and costs for transportation of items to a cluster, within a cluster, between clusters, and the like.

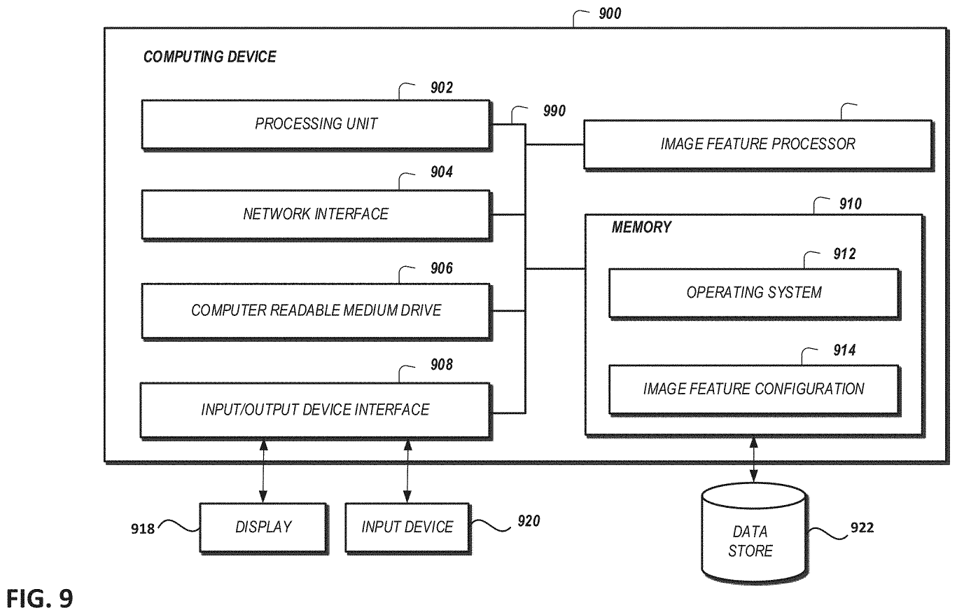

FIG. 9 is a block diagram of a computing device 900 for implementing the SPLOT creating and managing methods described above with respect to FIGS. 2 and 4-7. FIG. 9 is merely an example block diagram, and certain elements may be removed, other elements added, two or more elements combined or one element can be separated into multiple elements depending on the specification and requirements.

The computing device 900 can be a server or other computing device, and can include a processing unit 902, an image feature processor 930, a network interface 904, a computer readable medium drive 906, an input/output device interface 908, and a memory 910. In some embodiments, the computing device 900 may implement the features of one or more of the processors 310-318 and 322 shown in FIG. 3. In other embodiments, at least some elements of the computing device 900 may be included in one or more of the processors 310-318 and 322 to perform an entirety or part of the flow diagrams shown in FIGS. 2 and 4-7. In still other embodiments, the computing device 900 may be in data communication with one or more of the processors 310-318 and 322 to perform an entirety or part of the procedures shown in FIGS. 2 and 4-7.

The network interface 904 can provide connectivity to one or more networks or computing systems. The network interface 904 can receive information and instructions from other computing systems or services via the network interface 904. The network interface 904 can also store data directly to the memory 910. The processing unit 902 can communicate to and from the memory 910 and output information to an optional display 918 via the input/output device interface 908. The input/output device interface 908 can also accept input from the optional input device 920, such as a keyboard, mouse, digital pen, microphone, mass storage device, etc.

The memory 910 may contain computer program instructions that the processing unit 902 executes in order to implement one or more of the embodiments described above. The memory 910 generally includes RAM, ROM, and/or other persistent, non-transitory computer readable media. The memory 910 can store an operating system 912 that provides computer program instructions for use by the processing unit 902 or other elements included in the computing device in the general administration and operation of the computing device 900. The memory 910 can further include computer program instructions and other information for implementing aspects of the present disclosure.

For example, in one embodiment, the memory 910 includes an image feature configuration 914. The image feature configuration 914 may include one or more desired orientations for displaying different types of items, regular expressions for sets of characters including the routing information (e.g., ZIP code), area(s) of pre-printed packaging material that may include address information or other routing information, or other information supporting the image based routing of items described herein. The image feature configuration 914 may store specific values for a given configuration. The image feature configuration 914 may, in some embodiments, store information for obtaining values for a given configuration. For example, an address information extraction service implementing the regular expressions for identifying the address information or identify destination location information extracted from an image may be specified as a network location (e.g., URL) in conjunction with username and password information to access the service. In such embodiments, a message including the extracted text (or portion thereof) may be provided to the service. A response message may include the extracted address or destination location information, if available.

The memory 910 may also include or communicate with one or more auxiliary data stores, such as data store 922. The data store 922 may electronically store data regarding mail pieces, image files, or finalization results therefore.

The elements included in the computing device 900 may be coupled by a bus 990. The bus 990 may be a data bus, communication bus, or other bus mechanism to enable the various components of the computing device 900 to exchange information.

In some embodiments, the computing device 900 may include additional or fewer components than are shown in FIG. 9. For example, a computing device 900 may include more than one processing unit 902 and computer readable medium drive 906. In another example, the computing device 900 may not be coupled to a display 918 or an input device 920. In some embodiments, two or more computing devices 900 may together form a computer system for executing features of the present disclosure.

In some embodiments, a non-transitory computer readable medium having stored thereon instructions which when executed by at least one computing device performs all or a portion of the methods described.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as specialized hardware, or as specific software instructions executable by one or more hardware devices, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. An image processing system can be or include a microprocessor, but in the alternative, the image processing system can be or include a controller, microcontroller, or state machine, combinations of the same, or the like configured to generate and analyze indicator feedback. An image processing system can include electrical circuitry configured to process computer-executable instructions. Although described herein primarily with respect to digital technology, an image processing system may also include primarily analog components. For example, some or all of the image file analysis and rotation notation features described herein may be implemented in analog circuitry or mixed analog and digital circuitry. A computing environment can include a specialized computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in specifically tailored hardware, in a specialized software module executed by an image processing system, or in a combination of the two. A software module can reside in random access memory (RAM) memory, flash memory, read only memory (ROM), erasable programmable read-only memory (EPROM), electrically erasable programmable read-only memory (EEPROM), registers, hard disk, a removable disk, a compact disc read-only memory (CD-ROM), or other form of a non-transitory computer-readable storage medium. An exemplary storage medium can be coupled to the image processing system such that the image processing system can read information from, and write information to, the storage medium. In the alternative, the storage medium can be integral to the image processing system. The image processing system and the storage medium can reside in an application specific integrated circuit (ASIC). The ASIC can reside in an access device or other monitoring device. In the alternative, the image processing system and the storage medium can reside as discrete components in an access device or other item processing device. In some embodiments, the method may be a computer-implemented method performed under the control of a computing device, such as an access device or other item processing device, executing specific computer-executable instructions.

Conditional language used herein, such as, among others, “can,” “could,” “might,” “may,” “e.g.,” and the like, unless specifically stated otherwise, or otherwise understood within the context as used, is generally intended to convey that certain embodiments include, while some embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each is present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some embodiments, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML document, fixed field message, comma separated message, or the like. A message may, in some embodiments, include a signal utilized to transmit one or more representations of the information. While recited in the singular, it will be understood that a message may be composed, transmitted, stored, received, etc. in multiple parts.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A method of electronically forming a plurality of local areas, the method comprising:
obtaining, by a processor, characteristic data for a geographical area;
creating, by the processor, a grid of the geographical area;
combining, by the processor, the characteristic data and the grid to produce a combined data set; and
dividing, by the processor, the geographical area into a plurality of geographic units based on the combined data set.

2. The method of claim 1, wherein the characteristic data comprises at least one of the following: item volume data or a number of delivery points for the geographical area, population data or vacancy data for the geographical area.

3. The method of claim 1, further comprising:
clustering, by the processor, geographic units having similar characteristics based on the combined data set to generate a plurality of clusters; and
generating, by the processor, the clustered geographic units on a computerized map, wherein the plurality of clusters are visually distinguishable.

4. The method of claim 1, wherein the combining is performed for a plurality of regions of the geographical area respectively having a plurality of distances from a geographical point, and wherein the plurality of distances comprise a smallest distance, at least one intermediate distance and a largest distance.

5. The method of claim 4, wherein the combining is performed sequentially for the plurality of regions from the smallest distance to the largest distance.

6. The method of claim 5, wherein the smallest distance is in the range of 0.1 mile to 10 miles, and wherein the largest distance is in the range of 2.5 miles to 3,000 miles.

7. The method of claim 4, wherein the combining is sequentially performed by 1 mile increment for 10 regions of the geographical area respectively having distances of 1-10 miles from the geographical point.

8. The method of claim 1, wherein the plurality of geographic units comprise a plurality of strategically plotted locations over time (SPLOTs), and wherein each of the SPLOTs has at least one characteristic, the method further comprising:
selecting, by the processor, at least one SPLOT, from the plurality of SPLOTs, having a first characteristic as a main SPLOT;
determining, by the processor, characteristics of SPLOTs surrounding the main SPLOT; and
grouping together, by the processor, SPLOTs having characteristics the same as or similar to the first characteristic.

9. The method of claim 8, wherein the characteristic comprises one or more of the following: the number of population density, the number of retail stores, schools and/or government offices, the number of priority mail 1 day services and volumes, a mail volume per population, a mail volume per land area, the number of businesses, the number of residential buildings, the number of vacant buildings, customer behavior, business partner behavior patterns, the number of addresses, the number of primary business partners per population, and the number of primary business partners per land area, for the selected geographical area.

10. The method of claim 8, wherein the grouping comprises:
defining, by the processor, at least one characteristic each having a weight to classify the SPLOTs;
ranking, by the processor, the SPLOTs based on the defined characteristic;
classifying, by the processor, SPLOTs having the same or similar ranks into the same group; and
creating, by the processor, a cluster including all SPLOTs in the same group.

11. The method of claim 1, wherein the plurality of geographic units comprise a plurality of strategically plotted locations over time (SPLOTs), and wherein each of the SPLOTs has at least one characteristic, the method further comprising:
defining, by the processor, one or more characteristics each having a weight to classify SPLOTs;
classifying, by the processor, the plurality of SPLOTS into clusters;
selecting, by the processor, at least one SPLOT from the SPLOTs to evaluate, wherein the selected SPLOT belongs to a first cluster;
calculating, by the processor, a weighted score for the selected SPLOT at a first point of time to obtain first ranking;
calculating, by the processor, a weighted score for the selected SPLOT at a second point of time different from the first point of time to obtain second ranking,
comparing, by the processor, the first and second rankings; and
managing, by the processor, the selected SPLOT based on the comparing.

12. The method of claim 11, further comprising:
maintaining, by the processor, the selected SPLOT in the first cluster when the second ranking is the same as the first ranking; or
re-clustering, by the processor, the selected SPLOT to another different cluster when the second ranking is different from the first ranking.

13. The method of claim 11, wherein the one or more characteristics comprise a plurality of characteristics, and wherein the weighted score comprises a sum of the weights or an average of the sum of the weights.

14. A system for electronically forming a plurality of local areas of commerce, the system comprising:
a database configured to store mail volume data, census data and vacancy data, for a geographical area; and
a processor in data communication with the database and configured to:
retrieve the mail volume data, the census data and the vacancy data, for the geographical area;
compute data relationships among the mail volume data, the census data and the vacancy data;
identify longitude and latitude coordinate values of the geographical area;
create an appropriate grid of the geographical area using decimal precision;
combine the computed data relationships and the created appropriated grid to produce a combined data set; and
divide the geographical area into a plurality of strategically plotted locations over time (SPLOTs) based on the combined data set.

15. The system of claim 14, wherein the processor is further configured to:
group SPLOTs having similar characteristics; and
indicate the grouped SPLOTs on a computerized map to be visually distinguishable from different groups of SPLOTs.

16. The system of claim 14, wherein the processor is further configured to:
select at least one SPLOT, from the plurality of SPLOTs, having a first characteristic as a main SPLOT;
determine characteristics of SPLOTs surrounding the main SPLOT;
determine SPLOTs having characteristics the same as or similar to the first characteristic;
group the determined SPLOTs together; and
indicate the grouped SPLOTs on a computerized map to be visually distinguishable from different groups of SPLOTs.

17. The system of claim 16, wherein the processor is further configured to:
define at least one characteristic each having a weight to classify the SPLOTs;
rank the SPLOTs based on the defined characteristic;
classify SPLOTs having the same or similar ranks into the same group; and
create a cluster including all SPLOTs in the same group.

18. The system of claim 16, wherein each of the SPLOTs comprises at least one item delivery point.

19. The system of claim 16, wherein the processor is further configured to:
define one or more characteristics each having a weight to classify the plurality of SPLOTs;
classify the plurality of SPLOTS into clusters;
select at least one SPLOT from the plurality of SPLOTs to evaluate, wherein the selected SPLOT belongs to a first cluster;
calculate a weighted score for the selected SPLOT at a first point of time to obtain first ranking;
calculate a weighted score for the selected SPLOT at a second point of time different from the first point of time to obtain second ranking;
compare the first and second rankings; and
manage the selected SPLOT based on the comparing.

20. The system of claim 19, wherein the processor is further configured to:
maintain the selected SPLOT in the first cluster when the second ranking is the same as the first ranking; or
re-cluster the selected SPLOT to another different cluster when the second ranking is different from the first ranking.
